(19) United States
(12) Patent Application Publication
(10) Pub. No.: US 2025/0014049 A1
(43) Pub. Date: Jan. 9, 2025

(54) SYSTEM AND METHOD FOR CALCULATING EMISSIONS AND MEASURING CARBON SEQUESTRATION LEVELS

(71) Applicant: Pratikkumar Shah, Dubai (AE)

(72) Inventor: Pratikkumar Shah, Dubai (AE)

(21) Appl. No.: 18/762,497

(22) Filed: Jul. 2, 2024

Related U.S. Application Data
(60) Provisional application No. 63/524,768, filed on Jul. 3, 2023.

(51) Int. Cl. G06Q 30/018; G06V 10/70; G06V 20/10; G06V 20/13; G06V 20/17; H04L 9/00

(52) U.S. Cl. CPC G06Q 30/018; G06V 10/70; G06V 20/13; G06V 20/17; G06V 20/188; H04L 9/50; G06Q 2220/00

(57) ABSTRACT

A processor-implemented method for calculating emissions and measuring carbon sequestration levels is provided. The method includes (i) registering, by a user device, a first entity associated with an amount of carbon emission and a second entity associated with an amount of carbon absorption to create an account in a blockchain-based system using user details, (ii) obtaining satellite images and the drone images of the land cover of the second entity from a satellite source database, (iii) monitoring the plurality of satellite images and the plurality of drone images of the land cover of the second entity by creating land coordinates to calculate a carbon sequestration level associated with the second entity using an AI model, and (iv) training the AI model using an algorithm by categorizing the carbon sequestration level with known species of the second entity and the known tree species includes a drone image and the date when the image is captured.

### BACKGROUND

### Technical Field

The embodiments herein generally relate to calculating emissions, more particularly, to a system and method for calculating emissions and measuring carbon sequestration levels.

### Description of the Related Art

Carbon dioxide (CO2) is a major greenhouse gas contributing to global warming, ozone layer depletion, and numerous environmental problems. The continuous increase of CO2 in the Earth's atmosphere has resulted in rising temperatures, climate change, and harmful effects on ecosystems. Additionally, CO2 poses health risks to humans and contributes to pollution of the air, water, and soil. To mitigate these effects and ensure a sustainable environment for future generations, it is essential to reduce carbon dioxide emissions.

Various attempts have been made to address these challenges, including afforestation, environmentally friendly technology, and government mandates. Afforestation involves planting trees to absorb CO2 from the atmosphere and mitigate global warming, though it is hampered by a lack of robust tracking mechanisms. Encouraging the adoption of technologies such as electric vehicles (EVs), hydrogen cell vehicles, and hybrids faces the obstacle of inadequate supporting infrastructure. Government regulations and international agreements like the Kyoto Protocol aim to curb carbon emissions but often have loopholes that allow industries to evade compliance. Additionally, laws and Corporate Social Responsibility (CSR) initiatives aim to prevent the use of old vehicles, restrict deforestation, and promote activities such as clean water and ocean clean-up, but they face challenges in enforcement and affordability.

Despite these efforts, there remains a need for a comprehensive and streamlined solution to simplify carbon market regulations, enhance sustainable finance mechanisms, and effectively address the ongoing increase in carbon emissions. Sustainable finance, which prioritizes environmental, social, and governance (ESG) goals, lacks structured mechanisms and platforms for efficient and transparent investment processes. This creates challenges for investors aiming to fund environmentally responsible projects, limiting the growth and impact of sustainable finance initiatives.

Accordingly, there remains a need for a more efficient method for mitigating and/or overcoming drawbacks associated with current methods.

### SUMMARY

In view of foregoing, an embodiment herein provides a processor-implemented method for calculating emissions and measuring carbon sequestration levels. The method includes registering, by a user device, a first entity associated with an amount of carbon emission and a second entity associated with an amount of carbon absorption to create an account in a blockchain-based system using user details. The method includes obtaining a plurality of satellite images and the plurality of drone images of the land cover of the second entity from a satellite source database. The method includes monitoring the plurality of satellite images and the plurality of drone images of the land cover of the second entity by creating land coordinates to calculate a carbon sequestration level associated with the second entity using an AI model. The method includes training the AI model using an algorithm by categorizing the carbon sequestration level with known species of the second entity. The known tree species includes a drone image and the date when the image is captured. The method includes transforming the plurality of satellite images the land cover of the second entity from the satellite source database into data usable by a carbon predictor module. The method includes obtaining a carbon footprint based on the amount of carbon emitted by the first entity by inputting consumption details of the first entity into the carbon predictor module using the trained AI model. The method includes generating a carbon credit based on the satellite image of the second entity and the trained AI model in the carbon predictor module by estimating the required to offset the amount of carbon emitted by the first entity. The method includes converting the carbon credits into Non-Fungible Tokens (NFTs) using blockchain technology. The method includes providing the NFT's to the second entity as a representation of their carbon credits. The method includes securing the carbon credits after the transfer to the first entity and second entity in the blockchain using smart contracts.

In some embodiments, the first entity's carbon emissions are categorized into (i) direct emissions from sources owned or controlled by the first entity, (ii) indirect emissions from purchased electricity, heat, or steam consumed by the first entity and (iii) other indirect emissions resulting from activities but arising from sources not owned or controlled by the first entity.

In some embodiments, the method includes categorizing the carbon sequestration level based on the type and age of the tree species identified in the satellite images.

In some embodiments, the AI model is trained using a dataset that includes historical carbon sequestration data and corresponding satellite images.

In some embodiments, the carbon predictor module transforms the plurality of satellite images and the plurality of drone images into data usable for carbon footprint analysis by employing a computational core based on algorithms processing activity data using chosen emission factors.

In some embodiments, the method includes verifying authenticity and integrity of the NFT's representing carbon credits through cryptographic methods.

In some embodiments, the smart contracts used to secure the carbon credits in the blockchain are automatically executed based on predefined conditions related to carbon emission and sequestration levels.

In some embodiments, the AI model incorporates weather data and land use changes to enhance the accuracy of carbon sequestration level calculations.

In some embodiments, the second entity's carbon sequestration level is monitored periodically to update the carbon credits based on real-time satellite imagery and a drone imagery.

In one aspect, one or more non-transitory computer readable storage mediums storing one or more sequences of instructions, which when executed by one or more processors, causes a processor implemented method for calculating emissions and measuring carbon sequestration levels. The one or more non-transitory computer readable storage mediums includes the step of registering, by a user device, a first entity associated with an amount of carbon emission and a second entity associated with an amount of carbon absorption to create an account in a blockchain-based system using user details. The one or more non-transitory computer readable storage mediums includes the step of obtaining a plurality of satellite images and the plurality of drone images of the land cover of the second entity from a satellite source database. The one or more non-transitory computer readable storage mediums includes the step of monitoring the plurality of satellite images and the plurality of drone images of the land cover of the second entity by creating land coordinates to calculate a carbon sequestration level associated with the second entity using an AI model. The one or more non-transitory computer readable storage mediums includes the step of training the AI model using an algorithm by categorizing the carbon sequestration level with known species of the second entity. The known tree species includes a drone image and the date when the image is captured. The one or more non-transitory computer readable storage mediums includes the step of transforming the plurality of satellite images and the plurality of drone images of the land cover of the second entity from the satellite source database into data usable by a carbon predictor module. The one or more non-transitory computer readable storage mediums includes the step of obtaining a carbon footprint based on the amount of carbon emitted by the first entity by inputting consumption details of the first entity into the carbon predictor module using the trained AI model. The one or more non-transitory computer readable storage mediums includes the step of generating a carbon credit based on the carbon sequestration level of the second entity in the carbon predictor module by estimating the number of carbon credits required to offset the amount of carbon emitted by the first entity. The one or more non-transitory computer readable storage mediums includes the step of converting the carbon credits into Non-Fungible Tokens (NFTs) using blockchain technology. The one or more non-transitory computer readable storage mediums includes the step of providing the NFTs to the second entity as a representation of their carbon credits. The method includes securing the carbon credits after the transfer to the first entity and second entity in the blockchain using smart contracts.

In some embodiments, the first entity's carbon emissions are categorized into (i) direct emissions from sources owned or controlled by the first entity, (ii) indirect emissions from purchased electricity, heat, or steam consumed by the first entity and (iii) other indirect emissions resulting from activities but arising from sources not owned or controlled by the first entity.

In some embodiments, the method includes categorizing the carbon sequestration level based on the type and age of the tree species identified in the satellite images and drone images.

In some embodiments, the AI model is trained using a dataset that includes historical carbon sequestration data and corresponding satellite images and drone images.

In some embodiments, the carbon predictor module transforms the plurality of satellite images and the plurality of drone images into data usable for carbon footprint analysis by employing a computational core based on algorithms processing activity data using chosen emission factors.

In some embodiments, the method includes verifying authenticity and integrity of the NFTs representing carbon credits through cryptographic methods.

In some embodiments, the smart contracts used to secure the carbon credits in the blockchain are automatically executed based on predefined conditions related to carbon emission and sequestration levels.

In some embodiments, the AI model incorporates weather data and land use changes to enhance the accuracy of carbon sequestration level calculations.

In some embodiments, the second entity's carbon sequestration level is monitored periodically to update the carbon credits based on real-time satellite imagery.

In another aspect, a system for calculating emissions and measuring carbon sequestration levels is provided. The system includes a memory that stores a set of instructions and a processor that executes the set of instructions and is configured to: (i) register, by a user device, a first entity associated with an amount of carbon emission and a second entity associated with an amount of carbon absorption to create an account in a blockchain-based system using user details, (ii) obtain a plurality of satellite images and a plurality of drone images of the land cover of the second entity from a satellite source database, (iii) monitor the plurality of satellite images and the plurality of drone images of the land cover of the second entity by creating land coordinates to calculate a carbon sequestration level associated with the second entity using an AI model, (iv) train the AI model using an algorithm by categorizing the carbon sequestration level with known species of the second entity, where the known tree species includes a drone image and the date when the image is captured, (v) transform the plurality of satellite images and the plurality of drone images of the land cover of the second entity from the satellite source database into data usable by a carbon predictor module, (vi) obtain a carbon footprint based on the amount of carbon emitted by the first entity by inputting consumption details of the first entity into the carbon predictor module using the trained AI model, (vii) generate a carbon credit based on the satellite image of the second entity and the trained AI model in the carbon predictor module by estimating the required to offset the amount of carbon emitted by the first entity, (viii) convert the carbon credits into Non-Fungible Tokens (NFTs) using blockchain technology, (ix) provide the NFTs to the second entity as a representation of their carbon credits and (x) secure the carbon credits after the transfer to the first entity and second entity in the blockchain using smart contracts.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system for calculating emissions and measuring carbon sequestration levels according to some embodiments herein;

FIGS. 2A-2E illustrate user interfaces of a user device associated with a user for estimating an amount of carbon emission in a particular location according to some embodiments herein;

FIG. 3 is an exemplary diagram that illustrates representing carbon credits as NFTs at a blockchain according to some embodiments herein;

FIG. 4 is a flow diagram that illustrates validation of carbon credits according to some embodiments herein;

FIGS. SA-5B are flow diagrams that illustrate a method for calculating emissions and measuring carbon sequestration levels according to some embodiments herein; and

FIG. 6 is a schematic diagram of a computer architecture in accordance with the embodiments herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

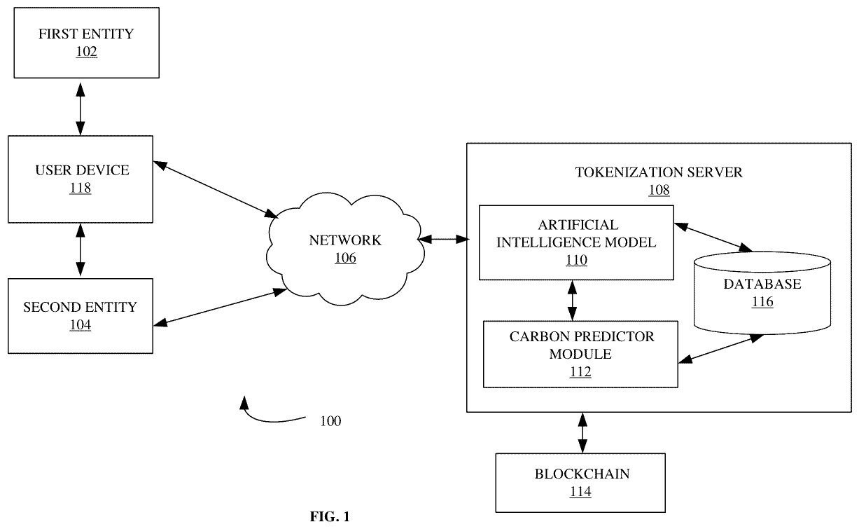

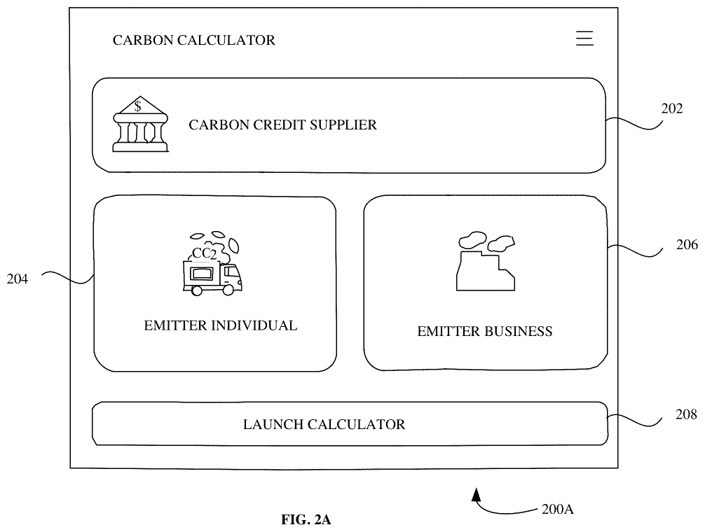

As mentioned, there is a need for calculating emissions and measuring carbon sequestration levels. Referring now to the drawings, and more particularly to FIGS. 1 through 6, where similar reference characters denote corresponding features consistently throughout the figures, preferred embodiments are shown.

### Definitions

Carbon footprint: The carbon footprint refers to the total amount of greenhouse gases, specifically carbon dioxide (CO2), released into the atmosphere as a result of human activities.

Carbon sequestration: Carbon sequestration is the process of capturing and storing atmospheric carbon dioxide. It is one method of reducing the amount of carbon dioxide in the atmosphere with the goal of reducing global climate change.

Carbon credits: The carbon credits represent a reduction in greenhouse gas emissions equivalent to one tonne of carbon dioxide, which can be traded and sold in the carbon market.

Smart contracts: The smart contract is a code written into a blockchain to execute an agreement or contract outside the blockchain.

Non-fungible token (NFT): NFT is a unique digital identifier or a token is recorded on a blockchain and used to certify ownership and authenticity.

Carbon Bank: The carbon bank is a platform for buying and selling carbon credits.

FIG. 1 is a block diagram of a system 100 for calculating emissions and measuring carbon sequestration levels according to some embodiments herein. The system 100 includes a first entity 102, a second entity 104, a network 106, a tokenization server 108, and the blockchain 114. The tokenization server 108 includes an Artificial intelligence (AI) model 110, and a carbon predictor module 112.

In some embodiments, the first entity 102 is an emitter and the second entity 104 is a converter. The first entity 102 is an emitter individual or an emitter business. In some embodiments, the first entity 102 is an individual such as a household, a transport vehicle, a small and medium enterprise (SME), and a large entity such as a power plant, or large factory. The first entity 102 may emit greenhouse gases (GHG) into the atmosphere. The GHGs include carbon dioxide (CO2), methane (CH4), nitrous oxide (N2O), and fluorinated gases. In some embodiments, the second entity 104 may be solar farms, private forests, light-emitting diode street lights, electric vehicles, etc. The second entity 104 may emit zero GHG to the atmosphere. In some embodiments, the second entity 104 emits low GHG into the atmosphere. For example, a renewable energy project that generates electricity from wind or solar power can be considered a converter because it produces zero greenhouse gas emissions. In some embodiments, the first entity 102, e.g., emitters can also become the second entity 104, e.g., converters by changing their source of energy. For example, when the first entity 102 replaces incandescent bulbs with light emitting diode (LED) or diesel generators with Solar panels, etc.

In some embodiments, the first entity 102 communicates with the tokenization server 108 using a user device 118 associated with the first entity 102. In some embodiments, the user device 118, without limitation, are selected from a mobile phone, a Personal Digital Assistant (PDA), a tablet, a desktop computer, a laptop computer, and the like.

The tokenization server 108 is interconnected with the first entity 102, the second entity 104, and the third party via the network 106. A list of devices that are capable of functioning as the tokenization server 108, without limitation, may include a server, a server network, a mobile phone, a Personal Digital Assistant (PDA), a tablet, a desktop computer, or a laptop. In some embodiments, the network 106 is a wired network. In some embodiments, the network 106 is a wireless network based on at least one Wi-Fi or Bluetooth. In some embodiments, the network 106 is a combination of a wired network and a wireless network. In some embodiments, the network 106 is the Internet.

The system 100 register the first entity 102 associated with an amount of carbon emission and the second entity 104 associated with an amount of carbon absorption to create an account in a blockchain-based system using user details by the user device 118.

The system 100 obtains plurality of satellite images and the plurality of drone images of the land cover of the second entity 104 from a satellite source database. The system 100 monitors the plurality of satellite images and the plurality of drone images of the land cover of the second entity 104 by creating land coordinates to calculate a carbon sequestration level associated with the second entity 104 using AI model 110. The satellite source database may include National Aeronautics and Space Administration (NASA), the European Space Research Organization (ESRO) and the Indian Space Research Organisation (ISRO).

The system 100 trains the AI model 110 using an algorithm by categorizing the carbon sequestration level with known species of the second entity 104. The known tree species comprises a drone image and the date when the image is captured. In some embodiments, the AI model 110 incorporates weather data and land use changes to enhance the accuracy of carbon sequestration level calculations. The weather data includes data from Weather Spark. The land use data is obtained from the NASA, ESRO and ISRO.

The AI model 110 captures and analyses specific areas associated with the first entity 102 and the second entity 104 in relation to their greenhouse gas (GHG) emissions. In some embodiments, the first area corresponds to an area where GHGs are emitted into the atmosphere as a result of activities conducted by individuals or organizations. In some embodiments, the second area corresponds to an area where no GHGs are emitted into the atmosphere as a result of activities conducted by individuals or organizations. In some embodiments, the AI model 110 includes a Google Earth satellite image to capture the specific areas associated with the first entity 102 and the second entity 104 in relation to their greenhouse gas (GHG) emissions.

The system 100 transforms the plurality of satellite images and the plurality of drone images of the first entity 102 from the satellite source database into data usable by a carbon predictor module 112. In some embodiments, the system 100 transforms the plurality of satellite images and the plurality of drone images of the land cover of the second entity 104 from the satellite source database into data usable by a carbon predictor module 112.

In some embodiments, the AI model 110 uses capabilities of Google Earth APIs and integrates multiple satellite datasets, including the MODIS (Moderate Imaging Spectroradiometer) sensor. This sensor facilitates calculation of carbon sequestration levels for land cover areas, which are delineated using polygons and evaluated using the Raster Data model. In some embodiments, the AI model 110 is trained by an algorithm that takes images of land from Google Earth with known species of tree and CO2 Sequestration Intensity per hectare of land and time of the year when the image was captured. In some embodiments, the tokenization server 108 includes a database 116 that stores the images of the land in different seasons and different locations. For example, the database 116 may store the images of 50 trees such as bamboo, cacti, eucalyptus, oak, pine, cedars, etc and for each tree species, the system 100 stores the images in different seasons and different locations in the database 116.

For each species of known tree, the database 116 includes a set of Drone image areas and images where the specific tree is planted. In some embodiments, the database 116 includes Coordinates, a Google Earth Image and a drone image, the Date in the year when the image was captured, and the CO2 Sequestration Intensity for that particular land for each tree species. In some embodiments, the AI model 110 monitors the growth of the trees.

The system 100 obtains a carbon footprint based on the amount of carbon emitted by the first entity 102 by inputting consumption details of the first entity 102 into the carbon predictor module 112 using the trained AI model. In some embodiments, the AI model 110 is trained using a dataset that includes historical carbon sequestration data. The carbon sequestration data includes reports, satellite images and Intergovernmental Panel on Climate (IPCC) datasets.

In some embodiments, the resulting Net Primary Productivity (NPP) estimates offer exceptional accuracy, enabling the capture of carbon sequestration rates on a daily, monthly, and yearly basis. In some embodiments, the AI model 110 utilizes diverse satellite datasets to capture images of tree cover, land cover, tree count, shrub count, and wetland distribution, providing valuable insights into the overall health of the land cover. The accuracy of the carbon capture calculations is reinforced by rigorous scientific verification methods, which allow for polygon-based delineation or the incorporation of multi-dimensional coordinates of the land cover.

The captured area of the first entity 102 and the second entity 104 is then transmitted to the carbon predictor module 112. The carbon predictor module 112 utilizes the AI model 110 to measure the carbon footprint of the first area associated with the emissions generated by the first entity 102. This measurement is conducted by analyzing the captured data and applying machine learning techniques to quantify the amount of carbon emitted. For example, the carbon emitted by the first entity 102 when manufacturing a product, driving a car, using electricity, or eating meat.

The carbon predictor module 112 utilizes the AI model 110 to estimate the carbon sequestration associated with the second entity 104. In some embodiments, the second area of the second entity 104 is measured using a polygon method through the AI/ML model 110.

The system 100 generates a carbon credit based on the satellite image of the second entity 104 and the trained AI model in the carbon predictor module 112 by estimating the required to offset the amount of carbon emitted by the first entity 102. The system 100 converts the carbon credits into Non-Fungible Tokens (NFTs) using blockchain technology.

The carbon predictor module 112 generates carbon credits for the second entity 104 based on carbon sequestration. The carbon predictor module 112 estimates the number of carbon credits that need to be purchased by the first entity 102 to offset the GHG emission. If the second entity 104 has the carbon credits earned through a project such as a renewable energy project or a carbon sequestration project, the second entity 104 can estimate the number of carbon credits that can be generated by their project using the carbon predictor module 112, thereby enabling the second entity 104 to determine the potential revenue that can be generated from selling the carbon credits in the carbon market.

In some embodiments, the amount of CO2 that has been reduced as a result of these activities is then measured and verified by the third party. In some embodiments, the third party is a government agency, a non-profit organization, or another independent entity that is responsible for ensuring the accuracy of the carbon credit calculations. In some embodiments, the carbon predictor module 112 is created by combining multiple data feeds and unit economics from various complex legacy-based Excel sheets found on governmental websites. Our innovation lies in simplifying the calculation process, allowing everyday users and businesses to easily input their emission data while obtaining accurate results.

The system 100 provides the NFT's to the second entity 104 as a representation of their carbon credits and secures the carbon credits after the transfer to the first entity 102 and second entity 104 in the blockchain 114 using smart contracts.

The blockchain 114 stores the carbon credits once the carbon credits are provided to the entities. The blockchain 114 is a digital ledger that is used to store and record information securely and transparently. The blockchain 114 maintains a record of credit ownership and the corresponding quantity of credits held by each entity. The blockchain 114 converts the carbon credits into NFTs, e.g., digital coins that can be bought and sold. In some embodiments, each token represents a certain number of carbon credits. For example, one token might represent one ton of CO2 that has been reduced. In some embodiments, the tokens can be bought and sold on a marketplace, which is like a virtual store where people can buy and sell things.

In some embodiments, the carbon credits are represented as Non-fungible tokens (NFTs) and ERC-20 tokens on the blockchain 114. In some embodiments, the NFTs include information about the carbon credit, including a name of a project, the number of carbon credits, the date of issuance, and the expiration date, and also any other information that can be stored. Each carbon credit is associated with an NFT that serves as a certificate of ownership. In some embodiments, users can buy and sell nature-based carbon credit tokens on a marketplace. The system 100 provides a user-friendly interface for searching, buying, and selling the carbon credit tokens.

The blockchain 114 uses smart contracts to ensure that the carbon credits being traded are valid and have not been used for personal offset. In some embodiments, the system 100 allows only valid carbon credits to be listed on the marketplace. In some embodiments, the system 100 ensures validation of the users who submit their Non-Fungible Token (NFT) certificates, commonly known as Proof of Carbon Credits (POCC), and successfully undergo a verification process before their carbon credit tokens can be listed for trading on the marketplace. If the NFT certificate fails the verification procedure, it will be rendered non-usable through a burning mechanism, effectively invalidating it.

In some embodiments, the system 100 enables the users, e.g., emitter individual or emitter business to create an account through a user device 118 at the tokenization server 108. The first entity 102 may receive at least one of a user ID, a chain ID, and a transaction Hash ID corresponding to a user account from the tokenization server 108.

In some embodiments, the system 100 provides an option for the users to create a decentralized wallet for storing their funds. The system 100 may enable the users to connect their existing decentralized wallets such as Metamask. In some embodiments, the users will be required to complete a basic know-your-customer (KYC) check before buying and selling carbon credit tokens on the system 100. The system 100 may use a 3rd party company for the KYC. In some embodiments, the system 100 enables buyers to purchase a portion of a carbon credit token, similar to how cryptocurrency is bought on trading platforms. This allows for more flexibility and accessibility for buyers with varying budgets. If the buyer purchases a portion of a carbon credit token, the seller's NFT certificate will be updated to reflect the change in the number of credits. Additionally, the buyer's wallet will be updated to include the carbon credit tokens they have purchased, along with an NFT certificate confirming their ownership of the tokens.

The system 100 enables the users to store and manage their carbon credit tokens in a wallet. The system 100 enables the users to buy carbon credit via fiat payment modes like Debit cards and Wire transfers also withdrawal may be possible for the same. The system 100 provides reporting and analytics tools that allow the users to track their carbon credit transactions and understand their impact on the environment. The system 100 can be integrated with other platforms for carbon credit trading, providing users with more options for buying and selling carbon credit tokens. The system 100 may be available in multiple languages, making it accessible to users around the world. In some embodiments, a secure admin panel may be provided to the system 100 to manage the system 100, monitor transactions, and approve/disapprove carbon credit token listings on the marketplace. In some embodiments, a referral system may be implemented on the system 100 to encourage users to invite friends and family to join and trade carbon credit tokens. In some embodiments, the system 100 provides notifications about new carbon credit token listings, completed transactions, and another important update to user devices associated with the users.

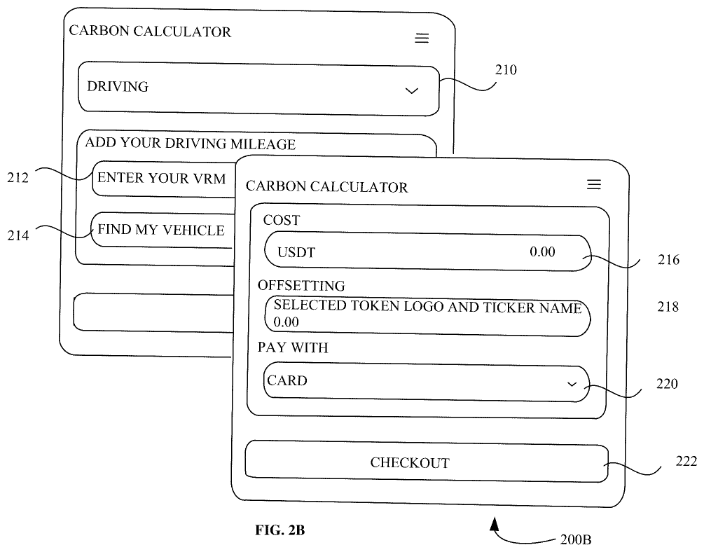

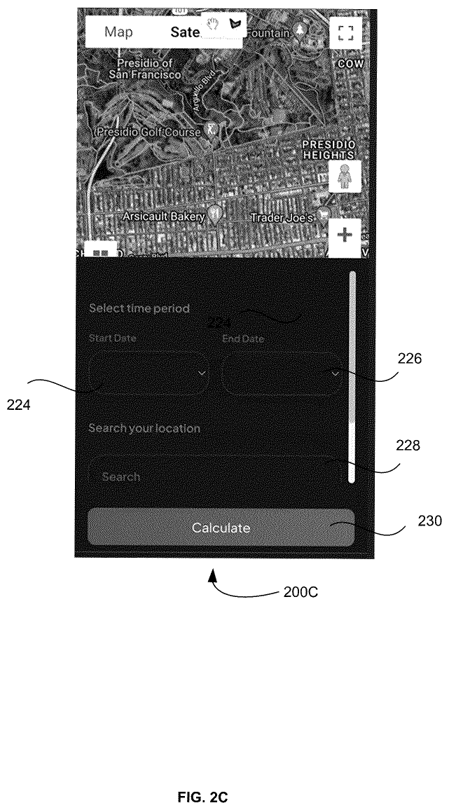

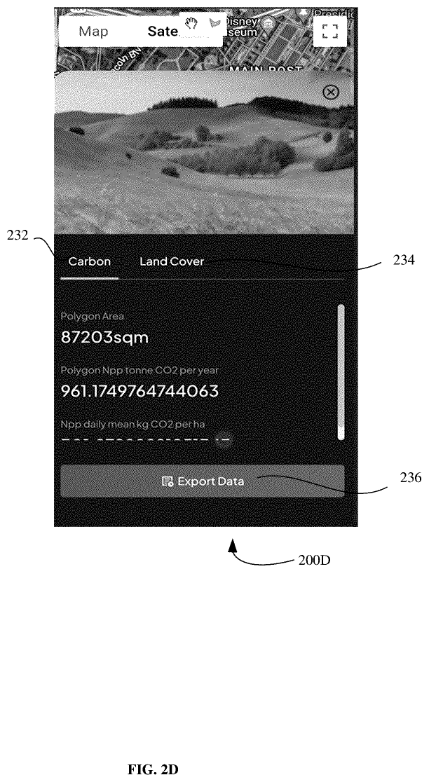

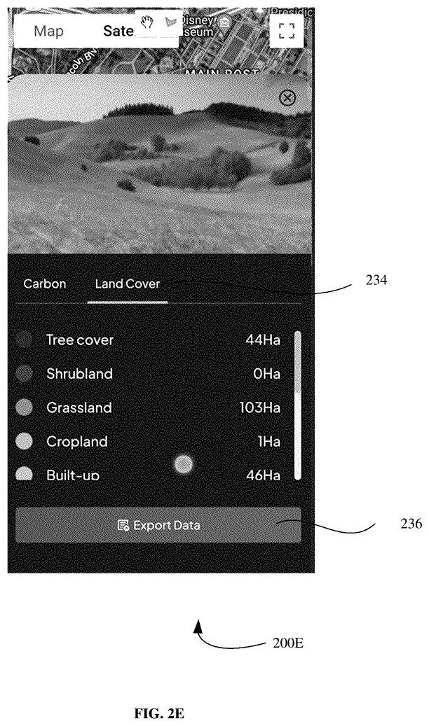

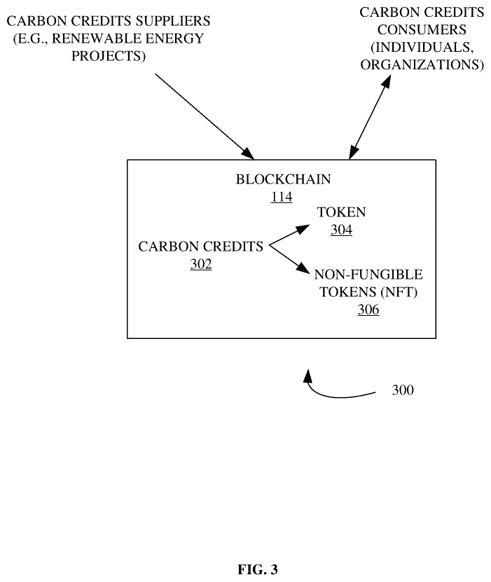

FIGS. 2A-2E illustrate user interfaces of a user device 118 associated with a user for estimating an amount of carbon emission in a particular location according to some embodiments herein.

In FIG. 2A of a user interface 200A, the tokenization server 108 enables the user, e.g., emitters to select categories such as Carbon Credit Supplier 202, Emitter individual 204, and Emitter business 206. The tokenization server 108 enables the user to start a process of estimating the amount of greenhouse gas emissions at launch calculator 208.

In FIG. 2B of a user interface 200B, the tokenization server 108 enables the user to select an activity, for example, driving a car, using electricity, or eating meat to estimate the total amount of carbon dioxide emissions associated with that activity. The user may select Driving 210. The tokenization server 108 enables the user to share Vehicle Registration Mark (VRM) 212 and find Vehicle 214. In the next tab, the tokenization server 108 enables the user to select cost 216, offsetting 218, e.g., Selected Token Logo and Ticker name, and payment options 220. The tokenization server 108 enables the user to check out 222 the amount of carbon credits that need to be purchased to offset these emissions. By measuring the carbon footprint of an individual or business, the tokenization server 108 can estimate the amount of carbon credits that need to be purchased to offset these emissions. If the second entity 104 is producing carbon credits through a project such as a renewable energy project or a carbon sequestration project, the tokenization server 108 enables the second entity 104 to estimate the number of carbon credits that can be generated by their project. This can help the second entity 104 to determine the potential revenue that can be generated from selling these credits in the carbon market.

In FIG. 2C of a user interface 200C, the tokenization server 108 enables the user to select time, i.e., start date 224, end date 226 as well as searching for specific locations 228 for calculating carbon emissions and land area 230.

In FIG. 2D of a user interface 200D, the tokenization server 108 enables the user to select carbon 232, e.g., Polygon area, Polygon NPP tonne CO2 per year, etc., along with land cover 234 and explore data 236.

In FIG. 2E of a user interface 200E, the tokenization server 108 enables the user to select the land cover 234, e.g., tree cover, Shrubland, Grassland along with carbon 232, and explore data 236. The tokenization server 108 enables the user to download data as a document.

FIG. 3 is an exemplary diagram 300 that illustrates representing carbon credits 302 as token 304 and NFTs 306 at the blockchain 114 according to some embodiments herein. The exemplary diagram 300 includes Carbon Credit Suppliers, Carbon Credit Consumers, the blockchain 114, and the Token 304 and NFTs 306. In some embodiments, the Carbon Credit Suppliers encompass entities such as renewable energy projects. The Carbon Credit Suppliers generate the carbon credits 302 through sustainable activities. An arrow connects the Carbon Credit Suppliers to the blockchain 114, indicating that the carbon credits 302 they generate are recorded and stored on the blockchain 114. In some embodiments, the Carbon Credit Consumers consist of individuals and organizations seeking to offset their carbon emissions or invest in sustainability initiatives. The Carbon Credit Consumers can access the blockchain 114 and trade the tokens 304.

The blockchain 114 stores the carbon credits 302 and converts the carbon credits 302 into the tokens 304 and NFTs 306, which are like digital coins that can be bought and sold. Both NFTs 306 and tokens 304, such as ERC-20 tokens on the blockchain 114, represent the carbon credits 302. The NFTs 306 includes information about the carbon credit, including the name of the project, the number of credits, the date of issuance, and the expiration date, and also any other information that might be needed can be stored in it. Each token 304 represents a certain number of carbon credits. For example, one token may represent one ton of CO2 that has been reduced. In some embodiments, the tokens 304 can be bought and sold on a marketplace, which is like a virtual store where people can buy and sell things.

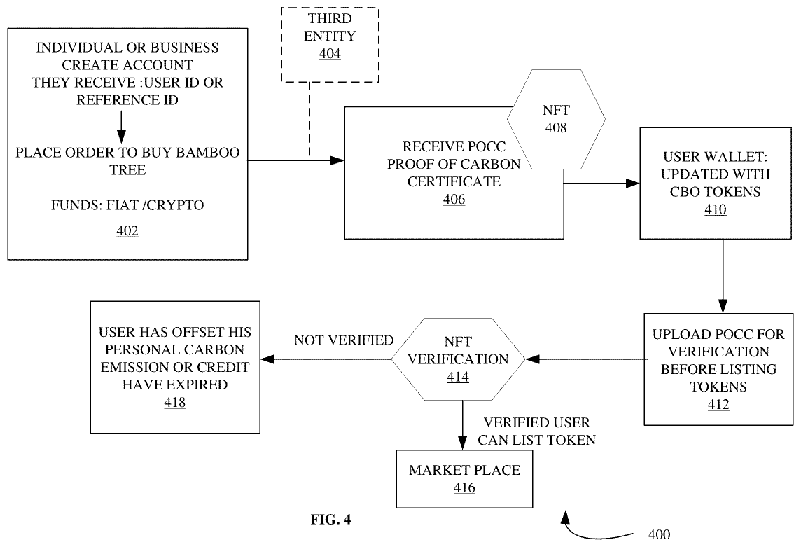

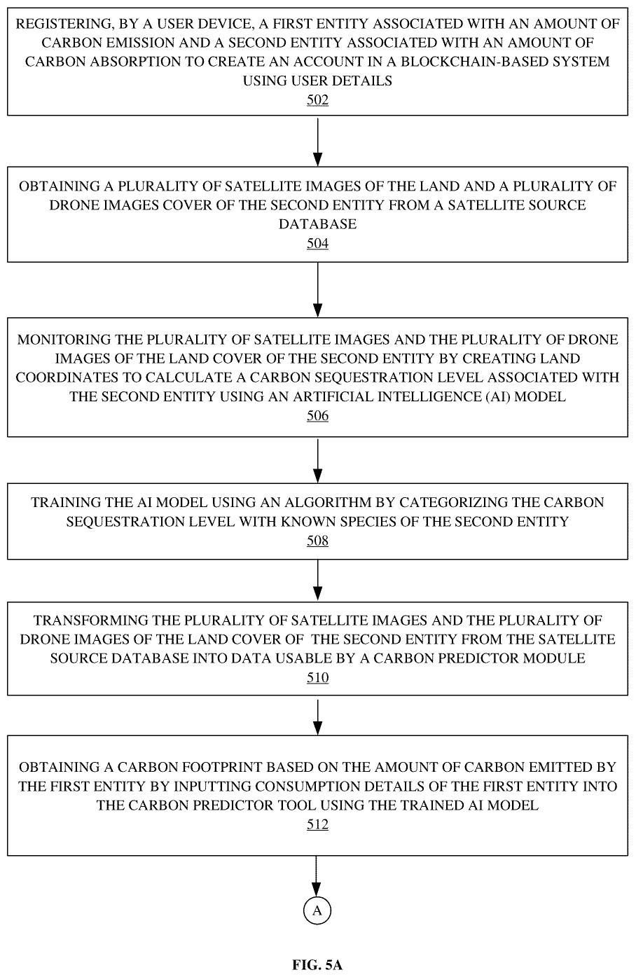

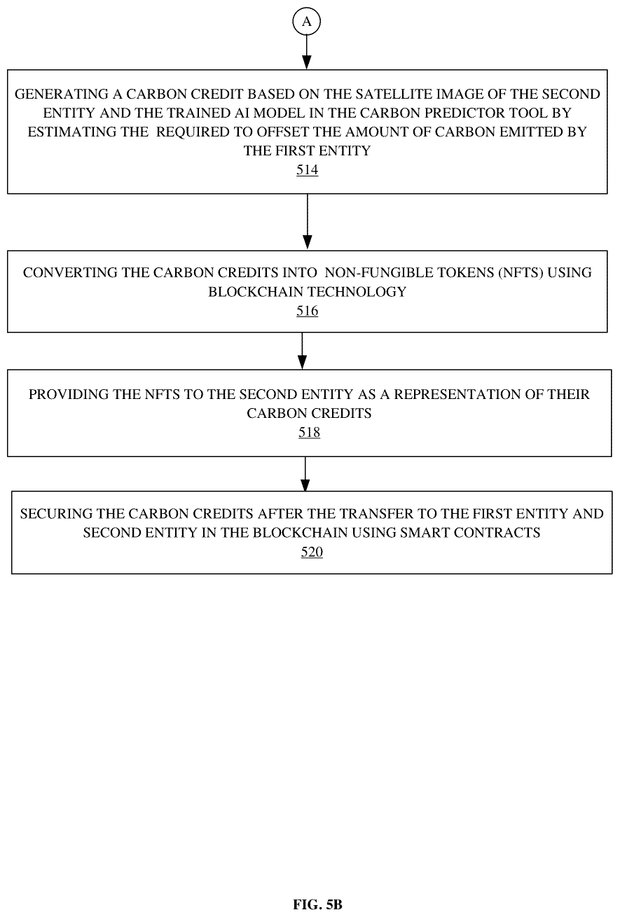

FIG. 4 is a flow diagram 400 that illustrates validation of carbon credits according to some embodiments herein. At step 402, creating an account by the users, e.g., emitter individual or emitter business through a user device 118 at the tokenization server 108. The users may receive at least one of a user ID, a chain ID, and a transaction Hash ID corresponding to a user account from the tokenization server 108. At step 404, receiving a proof of carbon credit certificate including a number of carbon credits, a number of bamboo trees, reference/user ID, and serial ID. At step 406, creating wallets to enable the user to store and manage their carbon credit tokens in the wallets. For example, one token might represent one ton of CO2. At step 408, uploading POCC for verification before listing tokens. In some embodiments, the user has to upload their NFT certificate (POCC) and pass a verification process at step 414 before they can list their carbon credit tokens on the marketplace at step 416. If the NFT certificate fails to pass the verification process at step 414, it will be burned, rendering it unusable at step 418.

FIGS. 5A-5B are flow diagrams that illustrate a method for calculating emissions and measuring carbon sequestration levels according to some embodiments herein. At step 502, the method includes registering, by a user device, a first entity associated with an amount of carbon emission and a second entity associated with an amount of carbon absorption to create an account in a blockchain-based system using user details. At step 504, the method includes obtaining a plurality of satellite images and the plurality of drone images of the land cover of the second entity from a satellite source database. At step 506, the method includes monitoring the plurality of satellite images and the plurality of drone images of the land cover of the second entity by creating land coordinates to calculate a carbon sequestration level associated with the second entity using an AI model. At step 508, the method includes training the AI model using an algorithm by categorizing the carbon sequestration level with known species of the second entity. The known tree species comprises a drone image and the date when the image is captured. At step 510, the method includes transforming the plurality of satellite images and the plurality of drone images of the land cover of the first entity or the second entity from the satellite source database into data usable by a carbon predictor module. At step 512, the method includes obtaining a carbon footprint based on the amount of carbon emitted by the first entity by inputting consumption details of the first entity into the carbon predictor module using a trained AI model. At step 514, the method includes generating a carbon credit based on the satellite image of the second entity and the trained AI model in the carbon predictor module by estimating the required to offset the amount of carbon emitted by the first entity. At step 516, the method includes converting the carbon credits into Non-Fungible Tokens (NFTs) using blockchain technology. At step 518, the method includes providing the NFTs to the second entity as a representation of their carbon credits. At step 520, the method includes securing the carbon credits after the transfer to the first entity and second entity in the blockchain using smart contracts.

The present invention discloses a system and method for tokenizing carbon credits using the blockchain. The system enables broader access to the carbon credit market by tokenizing carbon credits through a well-designed infrastructure. This allows a wide range of individuals and organizations to participate in the market, promoting inclusivity and increasing market activity.

The system leverages blockchain technology to ensure transparency and accountability in the tokenized carbon credit market. All transactions and relevant information are recorded on the blockchain, providing a reliable and auditable source of data. This transparency fosters trust among stakeholders and promotes responsible actions.

By tokenizing carbon credits on the blockchain, the system enhances security and minimizes the risk of fraud and manipulation. The decentralized nature of the blockchain, along with cryptographic techniques, guarantees the integrity of transactions, safeguarding the market from fraudulent activities.

The system simplifies processes and reduces administrative complexities by eliminating intermediaries and automating tasks through smart contracts. This streamlining improves operational efficiency and reduces transaction costs, making carbon credit trading more accessible and cost-effective.

The system enables global collaboration among different stakeholders in the carbon credit market, fostering cooperation and standardization. By providing a shared infrastructure, participants can securely interact, exchange information, and verify the authenticity of carbon credits. This collaborative approach facilitates collective efforts in addressing climate change challenges.

The system ensures the integrity and accuracy of carbon emissions data by storing it in a decentralized and immutable manner on the blockchain. This data can be used for precise measurement, reporting, and verification of emissions, enabling informed decision-making and reliable carbon offset calculations.

Through the system, tokenized incentives can be introduced to reward sustainable practices and emissions reductions. Smart contracts can be utilized to issue digital tokens as rewards for achieving specific targets or adopting environmentally friendly practices. These tokens can be traded or redeemed for carbon credits, providing economic incentives for sustainable behaviour.

The system for tokenizing carbon credits offers numerous advantages, including expanded market access, transparency, security, streamlined processes, global collaboration, reliable data management, and incentivized sustainability. These advantages contribute to a more efficient and effective carbon credit market, supporting global initiatives to mitigate climate change.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device.

In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening VO controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

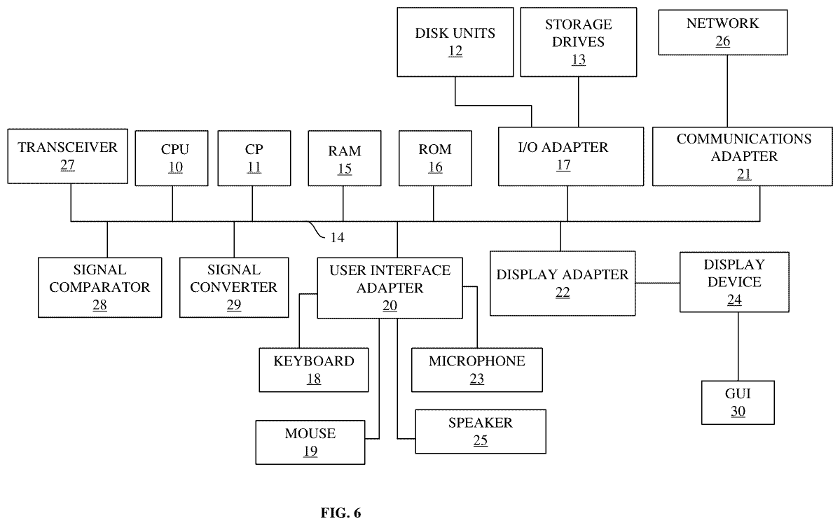

A representative hardware environment for practicing the embodiments herein is depicted in FIG. 6, with reference to FIGS. 1 through 5. This schematic drawing illustrates a hardware configuration of a server/computer system/user device in accordance with the embodiments herein. The tokenization server 108 includes at least one processing device 10. The special-purpose CPUs 10 are interconnected via system bus 12 to various devices such as a random-access memory (RAM) 14, read-only memory (ROM) 16, and an input/output (I/O) adapter 18. The VO adapter 18 can connect to peripheral devices, such as disk units 11 and tape drives 13, or other program storage devices that are readable by the system. The viewer device 104A can read the inventive instructions on the program storage devices and follow these instructions to execute the methodology of the embodiments herein. The viewer device 104A further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23, which provides a graphical user interface (GUI) 29 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for calculating emissions and measuring carbon sequestration levels, comprising:
registering, by a user device, a first entity associated with an amount of carbon emission and a second entity associated with an amount of carbon absorption to create an account in a blockchain-based system using user details;
obtaining a plurality of satellite images and the plurality of drone images of the land cover of the second entity from a satellite source database;
monitoring the plurality of satellite images and the plurality of drone images of the land cover of the second entity by creating land coordinates to calculate a carbon sequestration level associated with the second entity using an Artificial Model (AI) model;
training the AI model using an algorithm by categorizing the carbon sequestration level with known species of the second entity, wherein the known tree species comprises the plurality of drone images and the date when the image is captured;
transforming the plurality of satellite images and the plurality of drone images of the first entity or the second entity from the satellite source database into data usable by a carbon predictor module;
obtaining a carbon footprint based on the amount of carbon emitted by the first entity by inputting consumption details of the first entity into the carbon predictor module using a trained AI model;
generating a carbon credit based on the satellite image of the second entity and the trained AI model in the carbon predictor module by estimating the required to offset the amount of carbon emitted by the first entity;
converting the carbon credits into Non-Fungible Tokens (NFTs) using blockchain technology;
providing the NFTs to the second entity as a representation of their carbon credits; and
securing the carbon credits after the transfer to the first entity and second entity in the blockchain using smart contracts.

2. The method of claim 1, wherein the first entity's carbon emissions are categorized into (i) direct emissions from sources owned or controlled by the first entity, (ii) indirect emissions from purchased electricity, heat, or steam consumed by the first entity and (iii) other indirect emissions resulting from activities but arising from sources not owned or controlled by the first entity.

3. The method of claim 1, further comprising:
categorizing the carbon sequestration level based on the type and age of the tree species identified in the satellite images.

4. The method of claim 1, wherein the AI model is trained using a dataset that includes historical carbon sequestration data and corresponding satellite images.

5. The method of claim 1, wherein the carbon predictor module transforms the plurality of satellite images and the plurality of drone images into data usable for carbon footprint analysis by employing a computational core based on algorithms processing activity data using chosen emission factors.

6. The method of claim 1, further comprising:
verifying authenticity and integrity of the NFTs representing carbon credits through cryptographic methods.

7. The method of claim 1, wherein the smart contracts used to secure the carbon credits in the blockchain are automatically executed based on predefined conditions related to carbon emission and sequestration levels.

8. The method of claim 1, wherein the AI model incorporates weather data and land use changes to enhance the accuracy of carbon sequestration level calculations.

9. The method of claim 1, wherein the second entity's carbon sequestration level is monitored periodically to update the carbon credits based on real-time satellite imagery and a drone imagery.

10. One or more non-transitory computer readable storage mediums storing one or more sequences of instructions, which when executed by one or more processors, causes a processor implemented method for calculating emissions and measuring carbon sequestration levels, comprising:
registering, by a user device, a first entity associated with an amount of carbon emission and a second entity associated with an amount of carbon absorption to create an account in a blockchain-based system using user details;
obtaining a plurality of satellite images and a plurality of drone images of the land cover of the second entity from a satellite source database;
monitoring the plurality of satellite images and the plurality of drone images of the land cover of the second entity by creating land coordinates to calculate a carbon sequestration level associated with the second entity using an Artificial Model (AI) model;
training the AI model using an algorithm by categorizing the carbon sequestration level with known species of the second entity, wherein the known tree species comprises a plurality of drone images and the date when the image is captured;
transforming the plurality of satellite images and the plurality of drone images of the land cover of the second entity from the satellite source database into data usable by a carbon predictor module;
obtaining a carbon footprint based on the amount of carbon emitted by the first entity by inputting consumption details of the first entity into the carbon predictor module using a trained AI model;
generating a carbon credit based on the satellite image of the second entity and trained AI model in the carbon predictor module by estimating the required to offset the amount of carbon emitted by the first entity;
converting the carbon credits into Non-Fungible Tokens (NFTs) using blockchain technology;
providing the NFTs to the second entity as a representation of their carbon credits; and
securing the carbon credits after the transfer to the first entity and second entity in the blockchain using smart contracts.

11. The one or more non-transitory computer readable storage mediums storing the one or more sequences of instructions of claim 10, wherein the first entity's carbon emissions are categorized into (i) direct emissions from sources owned or controlled by the first entity, (ii) indirect emissions from purchased electricity, heat, or steam consumed by the first entity and (iii) other indirect emissions resulting from activities but arising from sources not owned or controlled by the first entity.

12. The one or more non-transitory computer readable storage mediums storing the one or more sequences of instructions of claim 10, which when executed by one or more processors, further causes: categorizing the carbon sequestration level based on the type and age of the tree species identified in the satellite images and the drone images.

13. The one or more non-transitory computer readable storage mediums storing the one or more sequences of instructions of claim 10, wherein the AI model is trained using a dataset that includes historical carbon sequestration data and corresponding satellite images and drone images.

14. The one or more non-transitory computer readable storage mediums storing the one or more sequences of instructions of claim 10.

15. The one or more non-transitory computer readable storage mediums storing the one or more sequences of instructions of claim 10, which when executed by one or more processors, further causes verifying authenticity and integrity of the NFTs representing carbon credits through cryptographic methods.

16. The one or more non-transitory computer readable storage mediums storing the one or more sequences of instructions of claim 10, wherein the smart contracts used to secure the carbon credits in the blockchain are automatically executed based on predefined conditions related to carbon emission and sequestration levels.

17. The one or more non-transitory computer readable storage mediums storing the one or more sequences of instructions of claim 10, wherein the AI model incorporates weather data and land use changes to enhance the accuracy of carbon sequestration level calculations.

18. The one or more non-transitory computer readable storage mediums storing the one or more sequences of instructions of claim 10, wherein the second entity's carbon sequestration level is monitored periodically to update the carbon credits based on real-time satellite imagery and the drone imagery.

19. A system for calculating emissions and measuring carbon sequestration levels, said system comprising:
a memory that stores a set of instructions; and
a processor that executes the set of instructions and is configured to:
register, by a user device, a first entity associated with an amount of carbon emission and a second entity associated with an amount of carbon absorption to create an account in a blockchain-based system using user details;
obtain a plurality of satellite images and the plurality of drone images of the land cover of the second entity from a satellite source database;
monitor the plurality of satellite images and the plurality of drone images of the land cover of the second entity by creating land coordinates to calculate a carbon sequestration level associated with the second entity using an Artificial Model (AI) model;
train the AI model using an algorithm by categorizing the carbon sequestration level with known species of the second entity, wherein the known tree species comprises a plurality of drone images and the date when the image is captured;
transform the plurality of satellite images and the plurality of drone images of the land cover of the second entity from the satellite source database into data usable by a carbon predictor module;
obtain a carbon footprint based on the amount of carbon emitted by the first entity by inputting consumption details of the first entity into the carbon predictor module using a trained AI model;
generate a carbon credit based on the satellite image of the second entity and the trained AI model in the carbon predictor module by estimating the required to offset the amount of carbon emitted by the first entity;
convert the carbon credits into a Non-Fungible Tokens (NFTs) using blockchain technology;
provide the NFTs to the second entity as a representation of their carbon credits; and
secure the carbon credits after the transfer to the first entity and second entity in the blockchain using smart contracts.
